(19) United States
(12) Patent Application Publication
(10) Pub. No.: US 2024/0203082 A1
(43) Pub. Date: Jun. 20, 2024

(54) OBJECT DETECTION DEVICE, OBJECT DETECTION METHOD, AND OBJECT DETECTION PROGRAM

(71) Applicant: NEC Corporation, Tokyo (JP)

(72) Inventor: Mizuho KATAYAMA, Tokyo (JP)

(73) Assignee: NEC Corporation, Tokyo (JP)

(21) Appl. No.: 18/538,401

(22) Filed: Dec. 13, 2023

(30) Foreign Application Priority Data
Dec. 19, 2022 (JP) 2022-201797

(51) Int. Cl. G06V 10/22; G06V 10/24; G06V 10/26

(52) U.S. Cl. CPC G06V 10/225; G06V 10/23; G06V 10/245; G06V 10/26

(57) ABSTRACT

An object detection device includes a prediction unit which predicts an object presence area, which is an area where an object is present in a current image, based on results of object detection in a past image, a generation unit which generates an object presence partial area that includes a partial area of the predicted object presence area together with partial information, which is information indicating a position of the partial area in the predicted object presence area and a size of the partial area, a detection unit which detects partial objects that are part of the object by performing object detection on the generated object presence partial area, and a restoration unit which restores results of object detection in the current image by placing the partial objects detected using the generated partial information in the predicted object presence area.

This application is based upon and claims the benefit of priority from Japanese patent application No. 2022-201797, filed on Dec. 19, 2022, the disclosure of which is incorporated here in its entirety by reference.

### BACKGROUND

### Technical Field

The present invention relates to an object detection device, an object detection method, and an object detection program, and in particular to an object detection device, an object detection method, and an object detection program using an AI (Artificial Intelligence) system.

### Related Art

Object detection for traffic control systems by deep learning is being performed. Since immediacy is required for object detection, the edge (terminal) is more suitable than cloud computing as the entity to execute object detection. However, the performance of edge object detection is often inferior to that of server object detection.

Devices for improving the performance of the above object detection are described, for example, in International Publication No. WO 2012/164804 and Japanese Patent Application Laid-Open No. 2020-126394. International Publication No. WO 2012/164804 describes an object detection device that can speed up detection processing time without sacrificing detection performance, while performing object detection only by image recognition.

Japanese Patent Application Laid-Open No. 2020-126394 also describes an object motion estimation device that aims to improve the prediction accuracy of object states.

### SUMMARY

Therefore, it is an object of the present invention to provide an object detection device, an object detection method, and an object detection program that can reduce the degradation of the accuracy of object detection that occurs when a part of an image is used as a detection target.

An object detection device according to the present invention is an object detection device includes a prediction unit which predicts an object presence area, which is an area where an object is present in a current image, which is an image of the object captured at a predetermined time, based on results of object detection in a past image, which is an image of the object captured in the past than at the predetermined time, a generation unit which generates an object presence partial area that includes a partial area of the predicted object presence area together with partial information, which is information indicating a position of the partial area in the predicted object presence area and a size of the partial area, a detection unit which detects partial objects that are part of the object by performing object detection on the generated object presence partial area, and a restoration unit which restores results of object detection in the current image by placing the partial objects detected using the generated partial information in the predicted object presence area.

An object detection method according to the present invention is an object detection method includes predicting an object presence area, which is an area where an object is present in a current image, which is an image of the object captured at a predetermined time, based on results of object detection in a past image, which is an image of the object captured in the past than at the predetermined time, generating an object presence partial area that includes a partial area of the predicted object presence area together with partial information, which is information indicating a position of the partial area in the predicted object presence area and a size of the partial area, detecting partial objects that are part of the object by performing object detection on the generated object presence partial area, and restoring results of object detection in the current image by placing the partial objects detected using the generated partial information in the predicted object presence area.

An object detection program according to the present invention, causing a computer to execute a prediction process of predicting an object presence area, which is an area where an object is present in a current image, which is an image of the object captured at a predetermined time, based on results of object detection in a past image, which is an image of the object captured in the past than at the predetermined time, a first generation process of generating an object presence partial area that includes a partial area of the predicted object presence area together with partial information, which is information indicating a position of the partial area in the predicted object presence area and a size of the partial area, a detection process of detecting partial objects that are part of the object by performing object detection on the generated object presence partial area, and a restoration process of restoring results of object detection in the current image by placing the partial objects detected using the generated partial information in the predicted object presence area.

### BRIEF DESCRIPTION OF DRAWINGS

FIG. 1 is an explanatory diagram showing an example of object detection results for a past image and prediction results for object presence areas for a current image;

FIG. 2 is an explanatory diagram showing an example of a group of object presence areas and a group of object presence area fragments;

FIG. 3 is an explanatory diagram showing an example of a group of object presence area fragments and a group of object fragment detection frames;

FIG. 4 is an explanatory diagram showing an example of a final object detection result;

FIG. 5 is an explanatory diagram showing another example of the final object detection result;

FIG. 6 is a block diagram showing an example of the configuration of an object detection device of the first example embodiment of the present invention;

FIG. 7 is an explanatory diagram showing an example of a group of object presence areas and a group of object presence partial areas of the first example embodiment;

FIG. 8 is an explanatory diagram showing another example of the object presence partial area of the first example embodiment;

FIG. 9 is an explanatory diagram showing an example of a group of partial object detection frames of the first example embodiment;

FIG. 10 is an explanatory diagram showing an example of the process of detecting a target object from a current image by an object detection restoration unit 140 of the first example embodiment;

FIG. 11 is a flowchart showing an operation of the object detection process by the object detection device 100 of the first example embodiment;

FIG. 12 is a block diagram showing an example of the configuration of an object detection device of the second example embodiment of the present invention;

FIG. 13 is an explanatory diagram showing an example of the group of object presence areas and an object presence area composite image of the second example embodiment;

FIG. 14 is an explanatory diagram showing an example of the group of object detection frames of the second example embodiment;

FIG. 15 is a flowchart showing an operation of the object detection process by the object detection device 200 of the second example embodiment;

FIG. 16 is an explanatory diagram showing an example of a hardware configuration of an object detection device according to the present invention; and

FIG. 17 is a block diagram showing an overview of an object detection device according to the present invention.

### DETAILED DESCRIPTION

The following is a specific explanation regarding the problem of degradation of the accuracy of object detection by the above object detection system. The above assumed object detection system includes a setting means, a generating means, an object detection means, and an estimating means.

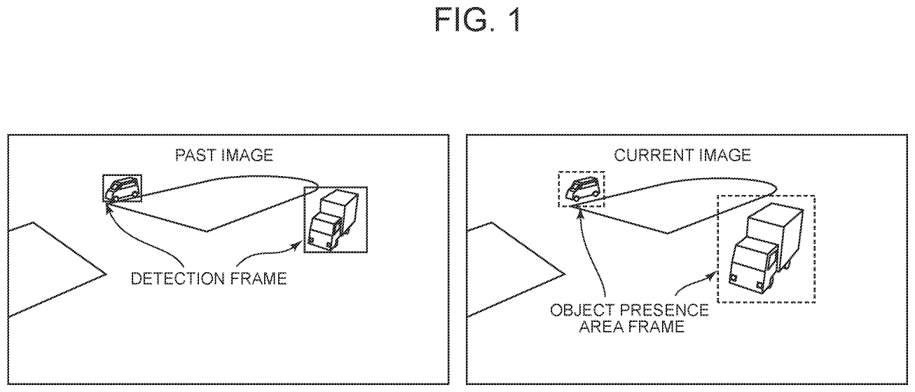

The setting means has the function of setting the area in the current image where an object is predicted to be present in the current image based on the location of the object detected in any past image. FIG. 1 is an explanatory diagram showing an example of object detection results for a past image and prediction results for object presence areas for a current image.

The detection frame in the past image shown in FIG. 1 represents the result of object detection for the past image. The object presence area frame in the current image shown in FIG. 1 represents the result of the prediction of the object presence area for the current image by the setting means.

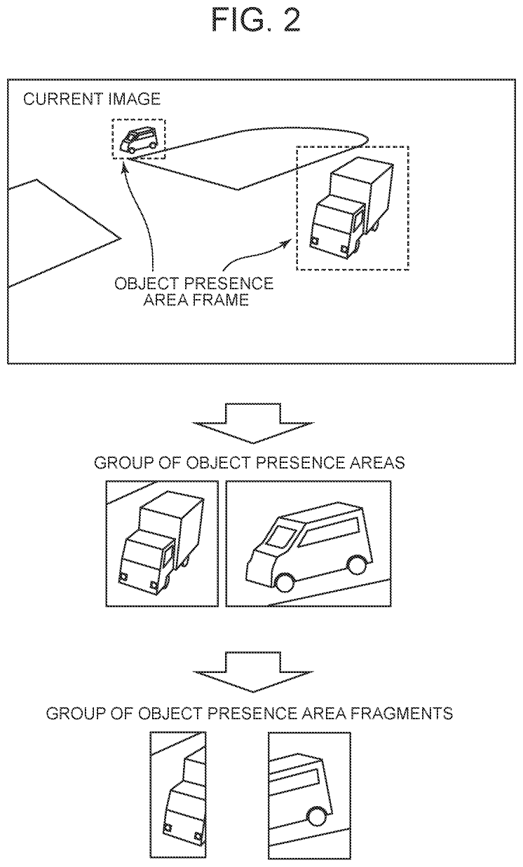

The generating means has the function of taking out a part of the set object presence area and generating a smaller fragment image from a part of the taken out object presence area. FIG. 2 is an explanatory diagram showing an example of a group of object presence areas and a group of object presence area fragments.

As shown in FIG. 2, the generating means takes out the object presence area frames set in the current image and generates a group of object presence areas. Next, the generating means generates a group of object presence area fragments by generating smaller fragment images (object presence area fragments) each from a part of each object presence area included in the group of object presence areas. In the example shown in FIG. 2, the generating means generates each fragment image by simply dividing each object presence area into two equal parts.

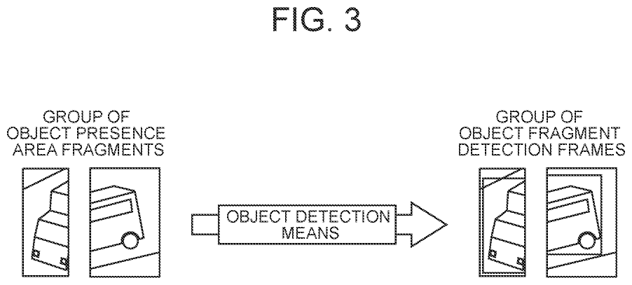

The object detection means has the function of determining the position and size of object fragments (partial objects) in the generated fragment image by performing object detection. FIG. 3 is an explanatory diagram showing an example of a group of object presence area fragments and a group of object fragment detection frames.

As shown in FIG. 3, the object detection means determines the position and size of each object fragment by performing object detection on each object presence area fragment included in the generated group of object presence area fragments, respectively. In the example shown in FIG. 3, the position and size of each object fragment is represented respectively by each rectangle (object fragment detection frame) surrounding a part of a vehicle in the group of object fragment detection frames.

The estimating means has the function of estimating the final object detection result based on the determined result by the object detection means. Specifically, the estimating means estimates the detection frame indicating the presence area of the target object in the current image from the detection frame detected in the past image and the detected object fragment.

For example, the estimating means estimates the horizontal or vertical size of the detection frame in the current image from the vertical and horizontal sizes of the detection frame acquired from the past image (hereinafter referred to as the vertical and horizontal sizes) and the vertical and horizontal sizes of the object fragment detection frame. The unit of size, such as pixels, is predetermined by the object detection system.

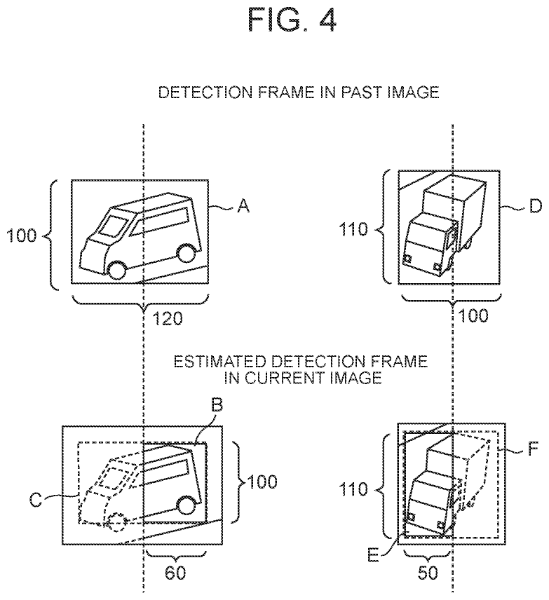

FIG. 4 is an explanatory diagram showing an example of a final object detection result. For example, in FIG. 4, suppose that the vertical and horizontal sizes of the detection frame A acquired from the past image are 120 and 100, respectively, and the vertical and horizontal sizes of the object fragment detection frame B are 60 and 100, respectively. Since the vertical size of the object fragment detection frame B is 100, the estimating means estimates the horizontal size of the detection frame C in the current image to be 100*120/100=120.

In estimating the horizontal size, the estimating means uses a variant of the proportionality equation (120/100)=(horizontal size of detection frame C/100). The object included in the detection frame C corresponds to the final object detection result.

Similarly, in FIG. 4, suppose that the vertical and horizontal sizes of the detection frame D acquired from the past image are 100 and 110, respectively, and the vertical and horizontal sizes of the object fragment detection frame E are 50 and 110, respectively. Since the vertical size of the object fragment detection frame E is 110, the estimating means estimates the horizontal size of the detection frame F in the current image to be 110*100/110=100.

The object included in the detection frame F corresponds to the final object detection result. The estimating means assumes that the aspect ratio of the past image is the same as that of the current image.

An object detection system having the above configuration operates as follows. First, the setting means predicts the rough position and size of the area including the object of the detection target. Next, the generating means generates a small fragment image by taking out a further part from the object presence area of the predicted image.

Next, the object detection means determines the position and size of the partial object by applying object detection to the generated fragment image. The estimating means then estimates the final object detection result based on the position and size of the determined partial object. The estimating means outputs the estimated detection result as the object detection result by the object detection system. After outputting the object detection result, the object detection system terminates the object detection process.

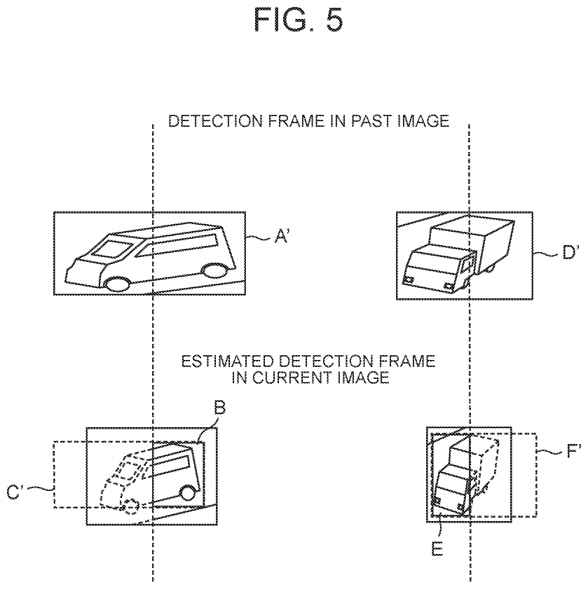

The reasons why the accuracy of object detection by the above object detection system deteriorates are explained below. FIG. 5 is an explanatory diagram showing another example of the final object detection result.

As shown in FIG. 5, if the aspect ratio of the past image is different from that of the current image, the estimating means estimates an inaccurate detection frame. For example, the horizontal size of detection frame A′ acquired from the past image shown in FIG. 5 is larger than the horizontal size of detection frame A shown in FIG. 4.

Therefore, the estimating means, which assumes that the aspect ratio of the past image is the same as that of the current image, estimates an inaccurate detection frame C′, whose horizontal size in the left half is larger than the horizontal size in the left half (60) of the detection frame C shown in FIG. 4. For the same reason, the estimating means estimates an inaccurate detection frame F′ whose horizontal size in the right half is larger than the horizontal size in the right half (50) of the detection frame F shown in FIG. 4.

For example, if the object of the detection target is a walking human with large arm or leg movements or a car in a curve, the aspect ratio of the past image may differ from that of the current image. If the aspect ratio of the past image differs from that of the current image, the object detection system may estimate an inaccurate detection frame in the current image, thus degrading the accuracy of object detection.

The present invention solves the problem of degrading the accuracy of object detection due to the above reasons. Each example embodiment of the present invention is described below with reference to the drawings.

In the following explanation, the current image is defined as the image of the target object captured at the current time and in which the target object is detected. The current image is, for example, an image sequentially captured by a fixed-point camera, etc. A fixed-point camera is, for example, a surveillance camera.

In the following explanation, the case in which the target object is a vehicle will be used as an example. The target object is not limited to the vehicle.

In each example embodiment, it is assumed that the target object has already been detected in the past image, which is an image of the target object captured in the past than the current time, and that information indicating the target object detected in the past image has been acquired. The past image is an image in which a situation similar to that displayed in the current image has been captured.

Information indicating the target object includes, for example, information indicating the presence area of the target object and an image showing a part including the target object.

The presence area of the target object is an area that includes the target object. The presence area of the target object is, for example, a rectangular area represented by the top-left vertex coordinate, as well as width and height. The presence area of the target object may also be a rectangular area represented by the top-left vertex coordinate and the bottom-right vertex coordinate.

A partial area of a predetermined image may be a rectangular image having a size less than or equal to the size of the predetermined image, a partial area cropped from the predetermined image, or the predetermined image itself.

### Example Embodiment 1

### Description of Configuration

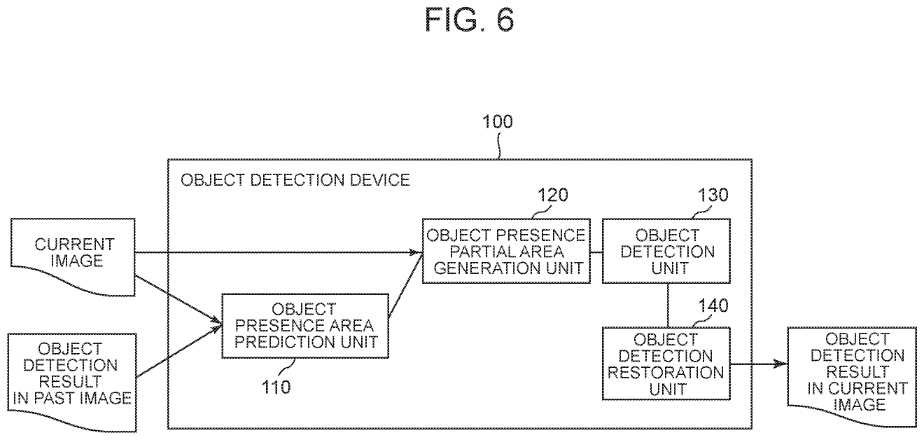

FIG. 6 is a block diagram showing an example of the configuration of an object detection device of the first example embodiment of the present invention. The object detection device 100 of this example embodiment computes and outputs the detection results of objects for the current image based on the detection results of partial objects for the current image, which is the input.

When reducing the amount of data in the image subject to object detection, the object detection device 100 of this example embodiment reduces the amount of data to the extent that the detection results of the target object can be restored, thereby speeding up the computation of object detection and improving its accuracy.

As shown in FIG. 6, the object detection device 100 of this example embodiment includes an object presence area prediction unit 110, an object presence partial area generation unit 120, an object detection unit 130, and an object detection restoration unit 140. Each component operates as outlined below.

The object presence area prediction unit 110 has the function of predicting the object presence area, which is the area where the object of the detection target is present in the current image, based on the object detection results in the past image.

The object presence area prediction unit 110 predicts the object presence area using a method based on a dynamic model such as the Kalman filter. The object presence area predicted by the object presence area prediction unit 110 is the same as the object presence area represented by the object presence area frame shown in FIG. 1.

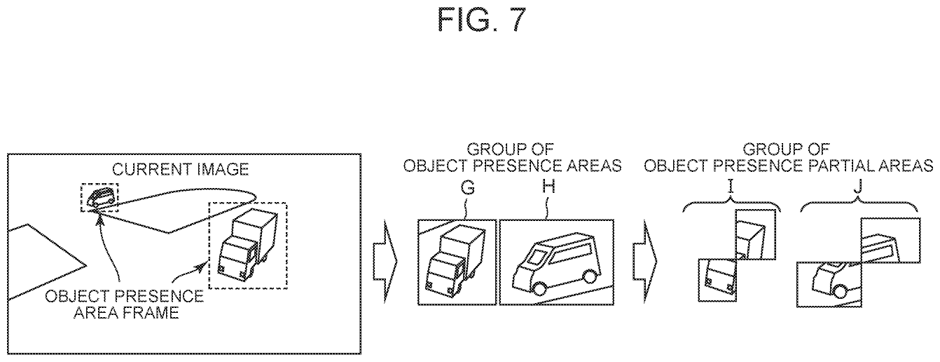

The object presence partial area generation unit 120 has the function of taking out parts of the object presence area and generating a group of object presence partial areas. FIG. 7 is an explanatory diagram showing an example of a group of object presence areas and a group of object presence partial areas of the first example embodiment.

As shown in FIG. 7, the object presence partial area generation unit 120 takes out the object presence area frame set in the current image to generate a group of object presence areas. Next, the object presence partial area generation unit 120 generates a group of object presence partial areas by taking out each object presence partial area from each object presence area included in the group of object presence areas.

The object presence partial area in this example embodiment includes one or more partial areas that display a part of the object of the detection target. The size of the partial area is large enough to enable the object detection unit 130 (described below) to detect a part of the object.

The two object presence partial areas included in the group of object presence partial areas shown in FIG. 7 both include at least two partial areas with two different vertices each located on the diagonal of the object presence area.

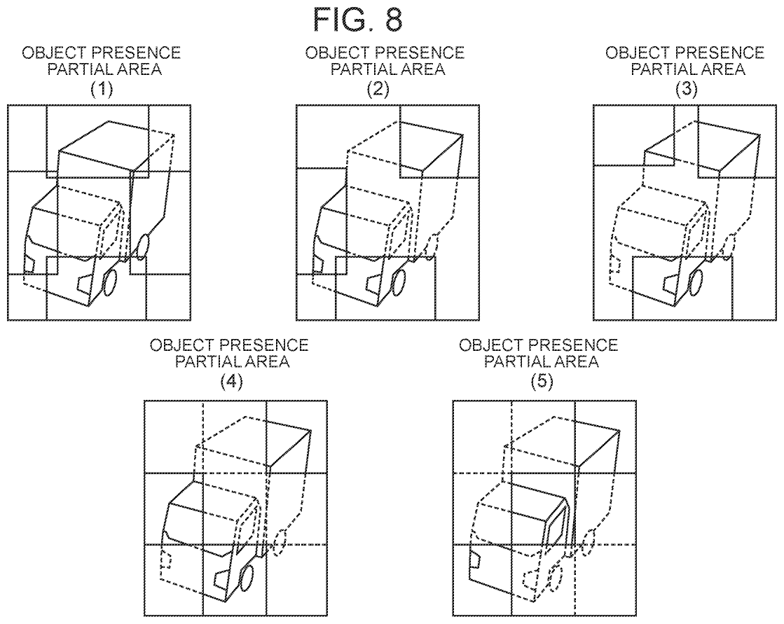

The object presence partial area of this example embodiment is not limited to the example shown in FIG. 7. FIG. 8 is an explanatory diagram showing another example of the object presence partial area of the first example embodiment Each rectangle in the image of the vehicle shown in FIG. 8 represents a partial area.

For example, the object presence partial area may include at least four partial areas, each with four different edges of the object presence area, such as the object presence partial area (1) shown in FIG. 8.

Alternatively, the object presence partial area may include at least one partial area with one vertex of the object presence area and two partial areas with two different edges each of the object presence area without the vertex, as in the object presence partial area (2) shown in FIG. 8.

Alternatively, the object presence partial area may include at least two partial areas, each with two different vertices of the object presence area and a partial area with one edge of the object presence area without those vertices, as in the object presence partial area (3) shown in FIG. 8.

Alternatively, the object presence partial area may include at least a plurality of partial areas among the N areas that make up the object presence area N-divided in a grid-like pattern (N is an integer of 2 or more), as in the object presence partial area (4) shown in FIG. 8.

Alternatively, the object presence partial area may include at least a plurality of partial areas located on the diagonal of the object presence area among the N areas make up the object presence area N-divided in a grid-like pattern, as in the object presence partial area (5) shown in FIG. 8.

The object presence partial area generation unit 120 may determine N according to the detection results of objects in the past image. For example, the object presence partial area generation unit 120 may set N to be larger the larger the size of the object of the detection target based on the object detection results in the past image. In other words, the object presence partial area generation unit 120 may set N so that the size of one partial area becomes smaller.

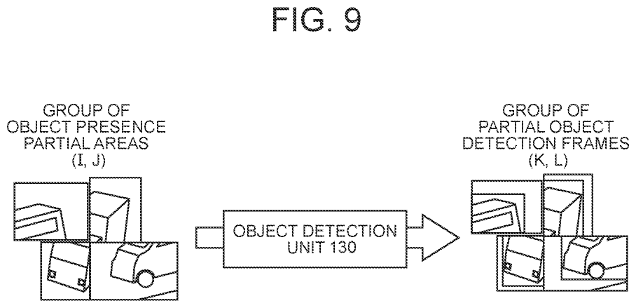

The object detection unit 130 has the function of performing object detection on the generated object presence partial areas. The object detection unit 130 computes partial objects, which are the detection results for the parts of object. FIG. 9 is an explanatory diagram showing an example of a group of partial object detection frames of the first example embodiment.

As shown in FIG. 9, the object detection unit 130 detects each partial object by executing object detection on each object presence partial area included in the generated group of object presence partial areas, respectively. In the example shown in FIG. 9, each partial object is represented by each rectangle (partial object detection frame) that surrounds a part of the vehicle in the group of partial object detection frames, respectively.

The object detection unit 130 may apply object detection to multiple object presence partial areas in a batch. The object detection unit 130 that detects partial objects does not necessarily have to be realized with an object detector dedicated for detecting a part of an object, but can be realized with a commonly used object detector such as Yolo (You Look Only Once). However, the object detector that realizes the object detection unit 130 is a high-performance detector capable of detecting objects even in an image showing a part of an object.

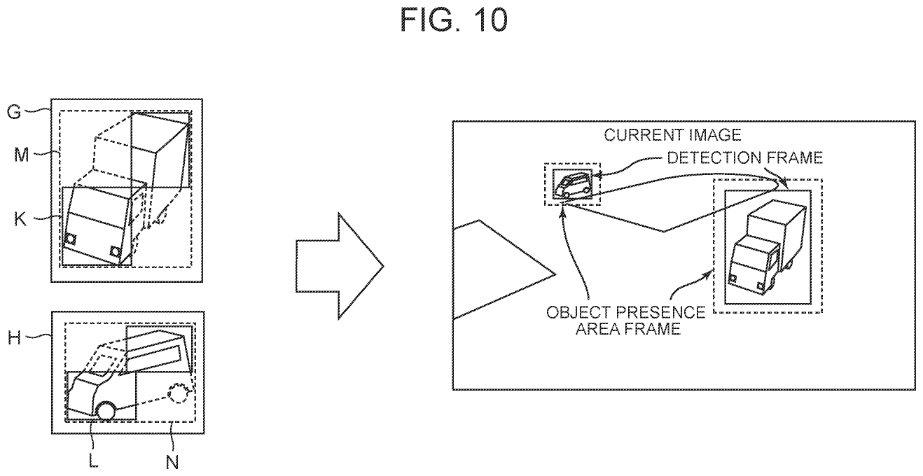

The object detection restoration unit 140 has the function of restoring the detection results of objects in the current image based on the detected partial objects. FIG. 10 is an explanatory diagram showing an example of the process of detecting a target object from a current image by an object detection restoration unit 140 of the first example embodiment.

In the example shown in FIG. 7, the object presence area prediction unit 110 predicts object presence areas G and H, respectively. In addition, the object presence partial area generation unit 120 generates object presence partial areas I and J, respectively.

As described above, for each of the rectangular object presence areas G and H, the object presence partial area generation unit 120 generates the object presence partial areas I and J, which include two partial areas each with two different vertices located on the diagonal of the object presence area. The object detection unit 130 obtains the partial object detection frames K and L shown in FIG. 9 by performing object detection on the object presence partial areas I and J, respectively.

When generating the object presence partial areas I and J, the object presence partial area generation unit 120 can record the parts of the object presence areas G and H where the partial areas included in the object presence partial areas were located. Therefore, based on the recorded information, the object detection restoration unit 140 can place the partial object detection frame K in the correct position for the object presence area G as shown in the left of FIG. 10.

Similarly, based on the recorded information, the object detection restoration unit 140 can place the partial object detection frame L in the correct position for the object presence area H as shown in the left of FIG. 10. Therefore, the object detection restoration unit 140 can restore the final object detection results M and N from the partial object detection frames K and L, respectively, as shown in the left of FIG. 10.

In addition to the information (placement information) of the part of the object presence area where the partial area was located, the object detection restoration unit 140 may also use the scaling ratio of the partial object or the size of the partial area to restore the object detection result in the current image. In other words, the object presence partial area generation unit 120 generates the object presence partial area together with the partial information, which is information indicating the position of the partial area in the predicted object presence area and the size of the partial area.

The object detection restoration unit 140 can compute the detection frame (detection result) of an object in the current image based on the scaling ratio and placement information of the partial object. In other words, the object detection restoration unit 140 can restore the result of object detection in the current image by placing the detected partial object in the predicted object presence area using the generated partial information.

In other words, the object detection restoration unit 140 can restore the detection results of objects in the current image without relying on information indicating the aspect ratio of the detection frame in the past image.

As described above, the object detection restoration unit 140 restores the object detection results from the group of partial object detection frames. The object detection device 100 outputs the restored detection results of the target object. As shown in the right of FIG. 10, a detection frame is set in the current image based on the outputted detection results of the target object.

As described above, the object presence area prediction unit 110 of this example embodiment predicts the object presence area, which is the area where an object is present in the current image, which is the image of an object captured at a predetermined time, based on the results of object detection in the past image, which is the image of an object captured in the past than at a predetermined time.

The object presence partial area generation unit 120 of this example embodiment also generates an object presence partial area that includes a partial area of the predicted object presence area together with partial information, which is information indicating the position of the partial area in the predicted object presence area and the size of the partial area.

The object detection unit 130 of this example embodiment detects partial objects that are part of an object by performing object detection on the generated object presence partial area.

The object detection restoration unit 140 of this example embodiment restores the results of object detection in the current image by placing partial objects detected using the generated partial information in the predicted object presence area.

The first effect of the object detection device 100 of this example embodiment is that it can reduce the degradation of detection accuracy. The reason for this is that when the object presence partial area generation unit 120 constructs the object presence partial area, it generates each partial area so that the target object can be restored.

The second effect of the object detection device 100 of this example embodiment is that the detection result of an object is obtained. The reason for this is that the object detection restoration unit 140 restores the object detection results from the detection results of partial objects.

### Description of Operation

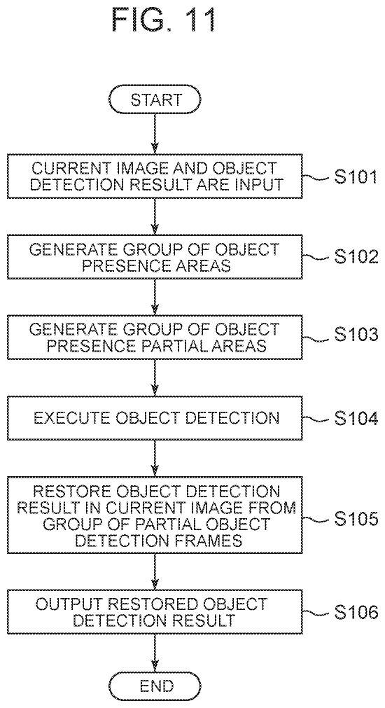

The operation for detecting an object of the object detection device 100 of this example embodiment will be described below with reference to FIG. 11. FIG. 11 is a flowchart showing an operation of the object detection process by the object detection device 100 of the first example embodiment.

The premise of the example shown in FIG. 11 is that an object has been detected for the past image corresponding to the current image.

First, the current image and the object detection result for the past image are input to the object detection device 100 (step S101). Next, the current image and the object detection result are input to the object presence area prediction unit 110. The current image is also input to the object presence partial area generation unit 120.

Next, the object presence area prediction unit 110 predicts object presence areas for the input current image based on the object detection result for the input past image. By predicting one or more object presence areas, the object presence area prediction unit 110 generates a group of object presence areas (step S102). The object presence area prediction unit 110 inputs the generated group of object presence areas to the object presence partial area generation unit 120.

Next, the object presence partial area generation unit 120 generates object presence partial areas for each object presence area included in the input group of object presence areas. The generated object presence partial areas are accompanied by partial information indicating the position and size of the partial areas included in the object presence partial areas.

By generating each object presence partial area, the object presence partial area generation unit 120 generates a group of object presence partial areas (step S103). The object presence partial area generation unit 120 inputs the generated group of object presence partial areas to the object detection unit 130.

Next, the object detection unit 130 detects each partial object by executing object detection on each object presence partial area included in the input group of object presence partial areas, respectively (step S104). By detecting each partial object, the object detection unit 130 generates a group of partial object detection frames. The object detection unit 130 inputs the generated group of partial object detection frames to the object detection restoration unit 140.

Next, the object detection restoration unit 140 restores the object detection results from the input group of partial object detection frames and makes them the object detection results in the current image (step S105). Next, the object detection restoration unit 140 outputs the restored object detection results in the current image (step S106). After outputting the object detection results, the object detection device 100 terminates the object detection process.

### Description of Effects

The object presence area prediction unit 110 of this example embodiment predicts the object presence area in the current image based on the object detection results in the past image. In addition, the object presence partial area generation unit 120 generates an object presence partial area, which is a set of partial areas of the object presence area.

The object detection unit 130 of this example embodiment executes object detection on the object presence partial area to detect partial objects. The object detection restoration unit 140 restores the object detection results in the current image from the detected partial objects.

Each of the above components performs object presence area prediction, object presence partial area computation, partial object detection, and object detection result restoration, respectively, to obtain object detection results in the current image.

Next, the effects of this example embodiment are explained. In this example embodiment, the object presence partial area generation unit 120 computes the object presence partial area by taking out a part of the object presence area, thus reducing the computation time for object detection.

In addition, because the object detection restoration unit 140 of this example embodiment does not depend on the object detection results in the past image when restoring the object detection results, the degradation of detection accuracy can be reduced even when the aspect ratio of the target object changes between the past and current images.

### Example Embodiment 2

### Description of Configuration

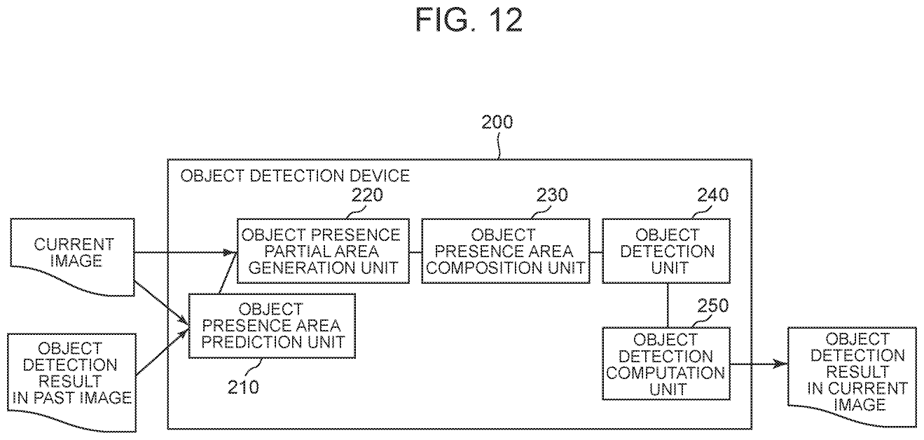

Next, a second example embodiment of the present invention will be described with reference to the drawings. FIG. 12 is a block diagram showing an example of the configuration of an object detection device of the second example embodiment of the present invention. The object detection device 200 of this example embodiment computes and outputs the object detection result in the current image based on the object detection result for the object presence area composite image in which multiple current images are composited.

As shown in FIG. 12, the object detection device 200 of this example embodiment includes an object presence area prediction unit 210, an object presence partial area generation unit 220, an object presence area composition unit 230, an object detection unit 240, and an object detection computation unit 250. Each component operates as outlined below.

The object presence area prediction unit 210 has the function of predicting the object presence area, which is the area where the object of the detection target is present in the current image, based on the object detection results in the past image.

The object presence area prediction unit 210 predicts the object presence area using a method based on a dynamic model such as the Kalman filter. The object presence area predicted by the object presence area prediction unit 210 is the same as the object presence area represented by the object presence area frame shown in FIG. 1.

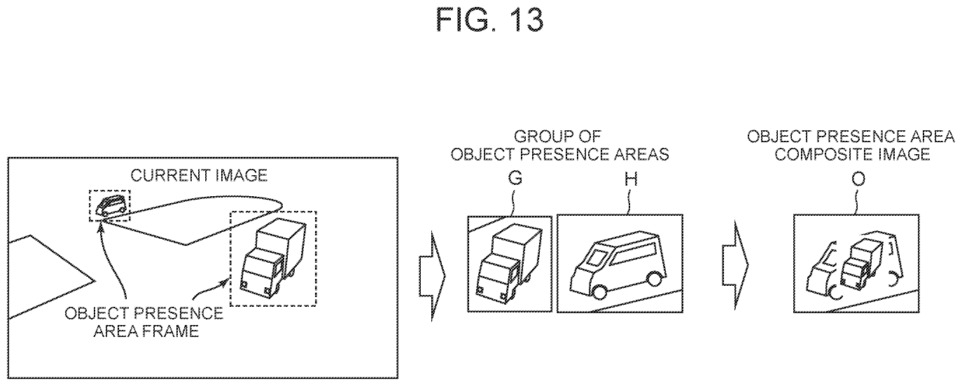

The object presence partial area generation unit 220 has the function of performing processing process on object presence areas. FIG. 13 is an explanatory diagram showing an example of the group of object presence areas and an object presence area composite image of the second example embodiment.

As shown in FIG. 13, the object presence partial area generation unit 220 takes out the object presence area frame set in the current image and generates a group of object presence areas.

Next, the object presence partial area generation unit 220 performs processing process on at least one object presence area included in the generated group of object presence areas. For example, the object presence partial area generation unit 220 rotates the object presence area or inverts the top, bottom, left, and right of the object presence area in the processing process.

The object presence partial area generation unit 220 may also enlarge or shrink the object presence area in the processing process. For example, for three object presence areas, the object presence partial area generation unit 220 may also shrink the second object presence area so that the second object presence area is smaller than the object of the detection target in the first object presence area. The object presence partial area generation unit 220 may also shrink the third object presence area so that the third object presence area is smaller than the object of the detection target in the shrunk second object presence area.

The object presence partial area generation unit 220 may change the transparency of the object presence area in the processing process. The object presence partial area generation unit 220 may not perform any processing on the object presence area in the processing process. The object presence partial area generation unit 220 inputs the processed object presence area to the object presence area composition unit 230.

The object presence partial area generation unit 220 also generates an object presence partial area by hollowing out the center of at least one object presence area included in the generated group of object presence areas. The object presence partial area generation unit 220 inputs the generated object presence partial area to the object presence area composition unit 230.

The object presence area composition unit 230 has the function of compositing the input object presence area and the object presence partial area into a single image. As shown in FIG. 13, the object presence area composition unit 230 generates a single object presence area composite image O by superimposing the shrunk object presence area G on the object presence partial area.

In other words, when compositing, the object presence partial area generation unit 220 generates an object presence partial area by hollowing out the center of the larger object presence area. Next, the object presence area composition unit 230 generates a single object presence area composite image by superimposing the shrunk object presence area on the hollowed-out area of the generated object presence partial area.

The object presence area composition unit 230 may also generate one object presence area composite image by superimposing three object presence areas that have been shrunk as described above. The object presence area composition unit 230 may also generate a single object presence area composite image by superimposing a rotated object presence area, an object presence area with its top, bottom, left and right sides inverted, or an object presence area with its transparency changed on other object presence partial areas.

The object presence area composition unit 230 may also generate a single object presence area composite image by superimposing other object presence areas on parts of the object presence partial area where the object of the detection target has not captured.

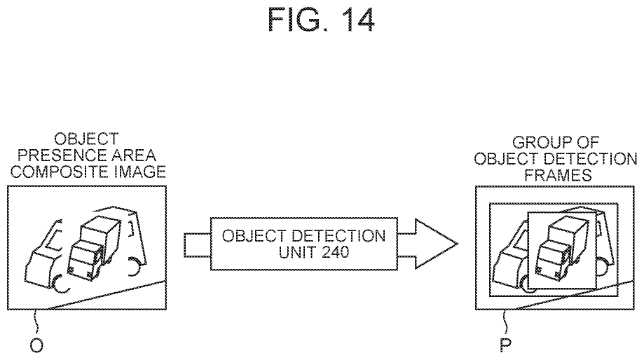

The object detection unit 240 has the function of performing object detection on the generated object presence area composite image. FIG. 14 is an explanatory diagram showing an example of the group of object detection frames of the second example embodiment.

As shown in FIG. 14, the object detection unit 240 detects each object that has been enlarged or shrunk by performing object detection on the generated object presence area composite image. In the example shown in FIG. 14, each object is represented by each rectangle (object detection frame) surrounding a vehicle in the group of object detection frames P, respectively. The object detection unit 240 may apply object detection to multiple object presence area composite images in a batch.

The object detection computation unit 250 has the function of computing the final object detection result in the current image based on the detected objects and such as the enlargement rate or shrinking rate of each object presence area in the object presence area composite image.

In the example shown in FIG. 13, the object presence area prediction unit 210 predicts object presence areas G and H, respectively. In addition, the object presence partial area generation unit 220 and the object presence area composition unit 230 generate the object presence area composite image O.

As described above, the object presence partial area generation unit 220 shrinks the rectangular object presence area G. The object presence area composition unit 230 generates an object presence area composite image O by superimposing the shrunk object presence area G on the object presence partial area. The object detection unit 240 obtains the group of object detection frames P shown in FIG. 14 by executing object detection on the generated object presence area composite image O.

When generating the object presence area composite image O, the object presence area composition unit 230 can record the part of the current image where each object presence area was located. Therefore, the object detection computation unit 250 can compute the final object detection result from the group of object detection frames P and the recorded information.

The object detection device 200 outputs the computed detection results of the target object. As shown in the right of FIG. 10, a detection frame is set in the current image based on the output detection results of the target object.

As described above, the object presence area composition unit 230 of this example embodiment composites object presence areas and object presence partial areas. The object presence partial area generation unit 220 performs processing process on at least one object presence area among the multiple predicted object presence areas to generate an object presence partial area from object presence areas other than at least one object presence area among the multiple predicted object presence areas.

The object presence area composition unit 230 generates one composite image by compositing the processed object presence area and the generated object presence partial area. The object detection unit 240 detects objects by performing object detection on the generated composite image.

### Description of Operation

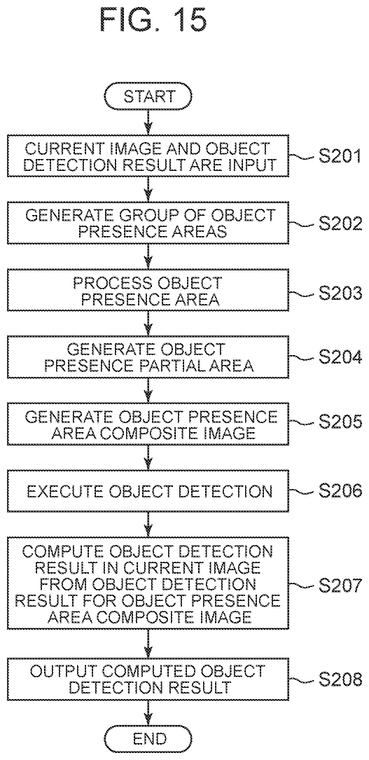

The operation for detecting an object of the object detection device 200 of this example embodiment will be described below with reference to FIG. 15. FIG. 15 is a flowchart showing an operation of the object detection process by the object detection device 200 of the second example embodiment.

Similar to the example shown in FIG. 11, the assumption for the example shown in FIG. 15 is that an object has been detected for the past image corresponding to the current image.

First, the current image and the object detection result for the past image are input to the object detection device 200 (step S201). Next, the current image and the object detection result are input to the object presence area prediction unit 210. The current image is also input to the object presence partial area generation unit 220.

Next, the object presence area prediction unit 210 predicts object presence areas for the input current image based on the object detection result for the input past image. By predicting one or more object presence areas, the object presence area prediction unit 210 generates a group of object presence areas (step S202). The object presence area prediction unit 210 inputs the generated group of object presence areas to the object presence partial area generation unit 220.

Next, the object presence partial area generation unit 220 performs processing process on at least one object presence area included in the input group of object presence areas (step S203). The object presence partial area generation unit 220 inputs the processed object presence area to the object presence area composition unit 230.

Next, the object presence partial area generation unit 220 generates an object presence partial area by hollowing out the center of at least one object presence area included in the input group of object presence areas (step S204). The object presence partial area generation unit 220 inputs the generated object presence partial area to the object presence area composition unit 230.

Next, the object presence area composition unit 230 generates an object presence area composite image using the input object presence area and object presence partial area (step S205). The object presence partial area generation unit 220 inputs the generated object presence area composite image to the object detection unit 240.

Next, the object detection unit 240 detects each object by executing object detection on the input object presence area composite image (step S206). By detecting each object, the object detection unit 240 generates a group of object detection frames. The object detection unit 240 inputs the generated group of object detection frames to the object detection computation unit 250.

Next, the object detection computation unit 250 computes the object detection results in the current image from the input group of object detection frames, i.e., the object detection results for the object presence area composite image (step S207).

Next, the object detection computation unit 250 outputs the object detection results in the computed current image (step S208). After outputting the object detection results, the object detection device 200 terminates the object detection process.

### Description of Effects

Next, the effects of this example embodiment will be explained. In this example embodiment, as in the first example embodiment, the object detection computation unit 250 does not depend on the object detection results in past image when computing the object detection results, thus reducing the degradation of detection accuracy even when the aspect ratio of the target object changes between the past and current images.

In addition, the object detection unit 240 in this example embodiment performs object detection on the object presence area composite image in which the object presence area and the object presence partial area are combined. Therefore, when the object detection device 200 is realized on a real computer, the object detection device 200 can perform object detection faster than when object detection is performed for each of multiple object presence areas.

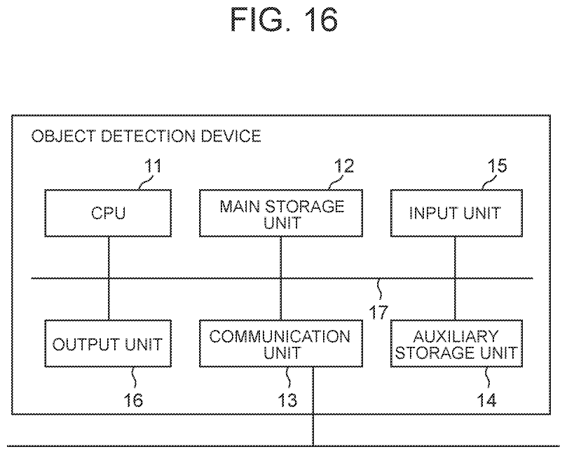

A specific example of a hardware configuration of the object detection device 100 and 200 according to each example embodiment will be described below. FIG. 16 is an explanatory diagram showing an example of a hardware configuration of an object detection device according to the present invention.

The object detection device shown in FIG. 16 includes a CPU (Central Processing Unit) 11, a main storage unit 12, a communication unit 13, and an auxiliary storage unit 14. The object detection device also includes an input unit 15 for the user to operate and an output unit 16 for presenting a processing result or a progress of the processing contents to the user.

The object detection device is realized by software, with the CPU 11 shown in FIG. 16 executing a program that provides a function that each component has.

Specifically, each function is realized by software as the CPU 11 loads the program stored in the auxiliary storage unit 14 into the main storage unit 12 and executes it to control the operation of the object detection device.

The object detection device shown in FIG. 16 may include a DSP (Digital Signal Processor) instead of the CPU 11. Alternatively, the object detection device shown in FIG. 16 may include both the CPU 11 and the DSP.

The main storage unit 12 is used as a work area for data and a temporary save area for data. The main storage unit 12 is, for example, RAM (Random Access Memory).

The communication unit 13 has a function of inputting and outputting data to and from peripheral devices through a wired network or a wireless network (information communication network).

The auxiliary storage unit 14 is a non-transitory tangible medium. Examples of non-transitory tangible media are, for example, a magnetic disk, an optical magnetic disk, a CD-ROM (Compact Disk Read Only Memory), a DVD-ROM (Digital Versatile Disk Read Only Memory), a semiconductor memory.

The input unit 15 has a function of inputting data and processing instructions. The input unit 15 is, for example, an input device such as a keyboard or a mouse.

The output unit 16 has a function to output data. The output unit 16 is, for example, a display device such as a liquid crystal display device, or a printing device such as a printer.

As shown in FIG. 16, in the object detection device, each component is connected to the system bus 17.

The auxiliary storage unit 14 stores programs for realizing the object presence area prediction unit 110, the object presence partial area generation unit 120, the object detection unit 130, and the object detection restoration unit 140 in the object detection device 100 of the first example embodiment.

The object detection device 100 may be implemented with a circuit that contains hardware components inside such as an LSI (Large Scale Integration) that realize the functions shown in FIG. 6, for example.

The auxiliary storage unit 14 stores programs for realizing the object presence area prediction unit 210, the object presence partial area generation unit 220, the object presence area composition unit 230, the object detection unit 240, and the object detection computation unit 250 in the object detection device 200 of the second example embodiment.

The object detection device 200 may be implemented with a circuit that contains hardware components inside such as an LSI that realize the functions shown in FIG. 12, for example.

The object detection device 100 and 200 may be realized by hardware that does not include computer functions using elements such as a CPU. For example, some or all of the components may be realized by a general-purpose circuit (circuitry) or a dedicated circuit, a processor, or a combination of these. They may be configured by a single chip (for example, the LSI described above) or by multiple chips connected via a bus. Some or all of the components may be realized by a combination of the above-mentioned circuit, etc. and a program.

Some or all of each component of the object detection device 100 and 200 may be configured by one or more information processing devices which include a computation unit and a storage unit.

In the case where some or all of the components are realized by a plurality of information processing devices, circuits, or the like, the plurality of information processing devices, circuits, or the like may be centrally located or distributed. For example, the information processing devices, circuits, etc. may be realized as a client-server system, a cloud computing system, etc., each of which is connected via a communication network.

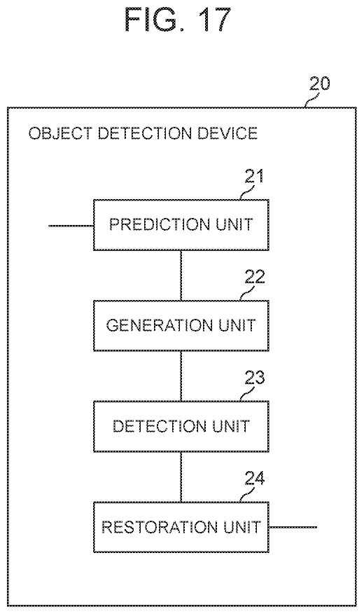

Next, an overview of the present invention will be explained. FIG. 17 is a block diagram showing an overview of an object detection device according to the present invention. The object detection device 20 according to the present invention includes a prediction unit 21 (for example, the object presence area prediction unit 110) which predicts an object presence area, which is an area where an object is present in a current image, which is an image of the object captured at a predetermined time, based on results of object detection in a past image, which is an image of the object captured in the past than at the predetermined time, a generation unit 22 (for example, the object presence partial area generation unit 120) which generates an object presence partial area that includes a partial area of the predicted object presence area together with partial information, which is information indicating a position of the partial area in the predicted object presence area and a size of the partial area, a detection unit 23 (for example, the object detection unit 130) which detects partial objects that are part of the object by performing object detection on the generated object presence partial area, and a restoration unit 24 (for example, the object detection restoration unit 140) which restores results of object detection in the current image by placing the partial objects detected using the generated partial information in the predicted object presence area.

The generation unit 22 may also generate the object presence partial area that includes at least two partial areas with two different vertices each located on the diagonal of the object presence area.

The generation unit 22 may also generate the object presence partial area that includes at least four partial areas, each with four different edges of the object presence area.

With such a configuration, the object detection device can reduce the degradation of the accuracy of object detection that occurs when a part of an image is used as a detection target.

The object detection device 20 may also include a composition unit (for example, the object presence area composition unit 230) which composites the object presence area and the object presence partial area. The generation unit 22 may also perform processing process on at least one object presence area among the multiple predicted object presence areas, and generate an object presence partial area from object presence areas other than at least the one object presence area among the multiple predicted object presence areas. The composition unit may also generate one composite image by compositing the processed object presence area and the generated object presence partial area. The detection unit 23 may also detect an object by performing object detection on the generated composite image.

The processing process may also be a process of rotating the object presence area, or a process of inverting the top, bottom, left, and right of the object presence area.

The processing process may also be a process of enlarging or shrinking the object presence area.

With such a configuration, the object detection device can perform object detection faster than when object detection is performed for each of multiple object presence areas.

The following is an example of poor object detection performance. To improve the execution speed of object detection, the inventor envisioned the object detection system described below. Considering the high computational load of object detection, in the envisioned object detection system, object detection is only performed on a part of the image to reduce the computational load.

The above object detection system has the problem of deteriorating detection accuracy. The reason for the problem is that the object detection system performs object detection after fragmenting the image displaying the object, and then estimates the result equivalent to the result of object detection performed on the original unfragmented image based on the result of object detection.

In other words, there is concern about degradation of detection accuracy when the above object detection system is used to target a part of an image for detection. International Publication No. WO 2012/164804 and Japanese Patent Application Laid-Open No. 2020-126394 do not describe a method to reduce the degradation of detection accuracy that occurs when a part of an image is used as a detection target.

The present invention can reduce the degradation of the accuracy of object detection that occurs when a part of an image is used as a detection target.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

Some or all of the aforementioned example embodiment can be described as supplementary notes mentioned below, but are not limited to the following supplementary notes.

### Supplementary Note 1

An object detection device comprising:
a prediction unit which predicts an object presence area, which is an area where an object is present in a current image, which is an image of the object captured at a predetermined time, based on results of object detection in a past image, which is an image of the object captured in the past than at the predetermined time;
a generation unit which generates an object presence partial area that includes a partial area of the predicted object presence area together with partial information, which is information indicating a position of the partial area in the predicted object presence area and a size of the partial area;
a detection unit which detects partial objects that are part of the object by performing object detection on the generated object presence partial area; and
a restoration unit which restores results of object detection in the current image by placing the partial objects detected using the generated partial information in the predicted object presence area.

### Supplementary Note 2

The object detection device according to Supplementary note 1, wherein
the generation unit generates the object presence partial area that includes at least two partial areas with two different vertices each located on the diagonal of the object presence area.

### Supplementary Note 3

The object detection device according to Supplementary note 1, wherein
the generation unit generates the object presence partial area that includes at least four partial areas, each with four different edges of the object presence area.

### Supplementary Note 4

The object detection device according to Supplementary note 1, wherein
the generation unit generates the object presence partial area that includes at least one partial area with one vertex of the object presence area and two partial areas with two different edges each of the object presence area without the vertex.

### Supplementary Note 5

The object detection device according to Supplementary note 1, wherein
the generation unit generates the object presence partial area that includes at least two partial areas, each with two different vertices of the object presence area and a partial area with one edge of the object presence area without those vertices.

### Supplementary Note 6

The object detection device according to Supplementary note 1, wherein
the generation unit generates the object presence partial area that includes at least a plurality of partial areas located on the diagonal of the object presence area among N areas make up the object presence area N-divided in a grid-like pattern.

### Supplementary Note 7

The object detection device according to Supplementary note 6, wherein the generation unit determines N according to object detection results in the past image.

### Supplementary Note 8

The object detection device according to Supplementary note 1, wherein the detection unit performs object detection to multiple object presence partial areas in a batch.

### Supplementary Note 9

The object detection device according to Supplementary note 1, further comprising:
a composition unit which composites the object presence area and the object presence partial area, wherein
the generation unit
performs processing process on at least one object presence area among the multiple predicted object presence areas, and
generates an object presence partial area from object presence areas other than at least the one object presence area among the multiple predicted object presence areas;
the composition unit
generates one composite image by compositing the processed object presence area and the generated object presence partial area; and
the detection unit
detects an object by performing object detection on the generated composite image.

### Supplementary Note 10

The object detection device according to Supplementary note 9, wherein
the processing process is a process of rotating the object presence area, or a process of inverting the top, bottom, left, and right of the object presence area.

### Supplementary Note 11

The object detection device according to Supplementary note 9, wherein the processing process is a process of enlarging or shrinking the object presence area.

### Supplementary Note 12

The object detection device according to Supplementary note 9, wherein
the processing process is a process of changing a transparency of the object presence area.

### Supplementary Note 13

The object detection device according to Supplementary note 9, wherein
the composition unit generates a composite image by superimposing other object presence areas on parts of the object presence partial area where the object of detection target has not captured.

### Supplementary Note 14

An object detection method comprising:
predicting an object presence area, which is an area where an object is present in a current image, which is an image of the object captured at a predetermined time, based on results of object detection in a past image, which is an image of the object captured in the past than at the predetermined time;
generating an object presence partial area that includes a partial area of the predicted object presence area together with partial information, which is information indicating a position of the partial area in the predicted object presence area and a size of the partial area;
detecting partial objects that are part of the object by performing object detection on the generated object presence partial area; and
restoring results of object detection in the current image by placing the partial objects detected using the generated partial information in the predicted object presence area.

### Supplementary Note 15

The object detection method according to Supplementary note 14, further comprising:
performing processing process on at least one object presence area among the multiple predicted object presence areas;
generating an object presence partial area from object presence areas other than at least the one object presence area among the multiple predicted object presence areas; generating one composite image by compositing the processed object presence area and the generated object presence partial area; and
detecting an object by performing object detection on the generated composite image.

### Supplementary note 16

An object detection program causing a computer to execute:
a prediction process of predicting an object presence area, which is an area where an object is present in a current image, which is an image of the object captured at a predetermined time, based on results of object detection in a past image, which is an image of the object captured in the past than at the predetermined time;
a first generation process of generating an object presence partial area that includes a partial area of the predicted object presence area together with partial information, which is information indicating a position of the partial area in the predicted object presence area and a size of the partial area;
a detection process of detecting partial objects that are part of the object by performing object detection on the generated object presence partial area; and
a restoration process of restoring results of object detection in the current image by placing the partial objects detected using the generated partial information in the predicted object presence area.

### Supplementary note 17

The object detection program according to Supplementary note 16, causing the computer to execute:
a processing process on at least one object presence area among the multiple predicted object presence areas;
a second generation process of generating an object presence partial area from object presence areas other than at least the one object presence area among the multiple predicted object presence areas;
a composition process of generating one composite image by compositing the processed object presence area and the generated object presence partial area; and
detect an object by performing object detection on the generated composite image in the detection process.

The present invention is suitable for applications such as traffic systems that detect vehicles and people by object detection, and inspection systems that detect and inspect products by object detection.

What is claimed is:

1. An object detection device comprising:
a memory configured to store instructions; and
a processor configured to execute the instructions to:
predict an object presence area, which is an area where an object is present in a current image, which is an image of the object captured at a predetermined time, based on results of object detection in a past image, which is an image of the object captured in the past than at the predetermined time;
generate an object presence partial area that includes a partial area of the predicted object presence area together with partial information, which is information indicating a position of the partial area in the predicted object presence area and a size of the partial area;
detect partial objects that are part of the object by performing object detection on the generated object presence partial area; and
restore results of object detection in the current image by placing the partial objects detected using the generated partial information in the predicted object presence area.

2. The object detection device according to claim 1, wherein the processor is further configured to execute the instructions to:
generate the object presence partial area that includes at least two partial areas with two different vertices each located on the diagonal of the object presence area.

3. The object detection device according to claim 1, wherein the processor is further configured to execute the instructions to:
generate the object presence partial area that includes at least four partial areas, each with four different edges of the object presence area.

4. The object detection device according to claim 1, wherein the processor is further configured to execute the instructions to:
generate the object presence partial area that includes at least one partial area with one vertex of the object presence area and two partial areas with two different edges each of the object presence area without the vertex.

5. The object detection device according to claim 1, wherein the processor is further configured to execute the instructions to:
generate the object presence partial area that includes at least two partial areas, each with two different vertices of the object presence area and a partial area with one edge of the object presence area without those vertices.

6. The object detection device according to claim 1, wherein the processor is further configured to execute the instructions to:
generate the object presence partial area that includes at least a plurality of partial areas located on the diagonal of the object presence area among N areas make up the object presence area N-divided in a grid-like pattern.

7. The object detection device according to claim 6, wherein the processor is further configured to execute the instructions to:
determine N according to object detection results in the past image.

8. The object detection device according to claim 1, wherein the processor is further configured to execute the instructions to:
perform object detection to multiple object presence partial areas in a batch.

9. The object detection device according to claim 1, wherein the processor is further configured to execute the instructions to:
composite the object presence area and the object presence partial area;
perform processing process on at least one object presence area among the multiple predicted object presence areas;
generate an object presence partial area from object presence areas other than at least the one object presence area among the multiple predicted object presence areas;
generate one composite image by compositing the processed object presence area and the generated object presence partial area; and
detect an object by performing object detection on the generated composite image.

10. The object detection device according to claim 9, wherein
the processing process is a process of rotating the object presence area, or a process of inverting the top, bottom, left, and right of the object presence area.

11. The object detection device according to claim 9, wherein
the processing process is a process of enlarging or shrinking the object presence area.

12. The object detection device according to claim 9, wherein
the processing process is a process of changing a transparency of the object presence area.

13. The object detection device according to claim 9, wherein the processor is further configured to execute the instructions to:
generate a composite image by superimposing other object presence areas on parts of the object presence partial area where the object of detection target has not captured.

14. An object detection method comprising:
predicting an object presence area, which is an area where an object is present in a current image, which is an image of the object captured at a predetermined time, based on results of object detection in a past image, which is an image of the object captured in the past than at the predetermined time;
generating an object presence partial area that includes a partial area of the predicted object presence area together with partial information, which is information indicating a position of the partial area in the predicted object presence area and a size of the partial area;
detecting partial objects that are part of the object by performing object detection on the generated object presence partial area; and
restoring results of object detection in the current image by placing the partial objects detected using the generated partial information in the predicted object presence area.

15. The object detection method according to claim 14, further comprising:
performing processing process on at least one object presence area among the multiple predicted object presence areas;
generating an object presence partial area from object presence areas other than at least the one object presence area among the multiple predicted object presence areas;
generating one composite image by compositing the processed object presence area and the generated object presence partial area; and
detecting an object by performing object detection on the generated composite image.

16. A computer-readable recording medium recording an object detection program causing a computer to execute:
predicting an object presence area, which is an area where an object is present in a current image, which is an image of the object captured at a predetermined time, based on results of object detection in a past image, which is an image of the object captured in the past than at the predetermined time;
generating an object presence partial area that includes a partial area of the predicted object presence area together with partial information, which is information indicating a position of the partial area in the predicted object presence area and a size of the partial area;
detecting partial objects that are part of the object by performing object detection on the generated object presence partial area; and
restoring results of object detection in the current image by placing the partial objects detected using the generated partial information in the predicted object presence area.

17. The recording medium recording the object detection program according to claim 16, causing the computer to execute:
performing processing process on at least one object presence area among the multiple predicted object presence areas;
generating an object presence partial area from object presence areas other than at least the one object presence area among the multiple predicted object presence areas;
generating one composite image by compositing the processed object presence area and the generated object presence partial area; and
detecting an object by performing object detection on the generated composite image.
